(19) United States
(12) Patent Application Publication
(10) Pub. No.: US 2015/0154810 A1
(43) Pub. Date: Jun. 4, 2015

(54) VIRTUAL TRANSPORTATION STANDS

(71) Applicants: Kar Leong TEW, Singapore (SG); Danqing CAI, Singapore (SG); Ziheng LIN, Singapore (SG); Tow Yang CHIAM, Singapore (SG); Sak Onn LEE, Singapore (SG); Kai Ling Bernice NG, Singapore (SG); Manning ZHANG, Singapore (SG)

(72) Inventors: Kar Leong TEW, Singapore (SG); Danqing CAI, Singapore (SG); Ziheng LIN, Singapore (SG); Tow Yang CHIAM, Singapore (SG); Sak Onn LEE, Singapore (SG); Kai Ling Bernice NG, Singapore (SG); Manning ZHANG, Singapore (SG)

(21) Appl. No.: 14/097,185

(22) Filed: Dec. 4, 2013

(51) Int. Cl. G07B 15/00; G06Q 50/30; G06Q 30/02

(52) U.S. Cl. CPC G07B 15/00; G06Q 30/0202; G06Q 50/30

(57) ABSTRACT

Described herein is a framework for coordinating transportation. In accordance with one implementation, the framework creates or selects a virtual transportation stand in response to a commuter request. The virtual transportation stand may be created or selected based at least in part on current location information associated with a mobile device. Information associated with the virtual transportation stand may then be provided to the commuter mobile device and a vehicle notification device. The virtual transportation stand may further be removed if it is no longer in demand.

### TECHNICAL FIELD

The present disclosure relates generally to computer systems, and more specifically, to a framework for creating and managing virtual transportation stands.

### BACKGROUND

Taxis are the main mode of public transportation for many people. Because of the efficiency and flexibility that taxi services offer, commuters are willing to pay higher fares to take a taxi rather than other modes of public transportation. As the population grows, however, providing sufficient taxi services to meet the demands of commuters has become a problem in many countries. From the taxi operators' perspective, taxi utilization rates are important since they are directly correlated to the profit they make. As for commuters, they desire both minimal waiting time and lower fares to reach their destinations on time.

Two solutions are widely implemented in many cities. The first solution is a booking service that the commuter can call to reserve a taxi at a specific time and location, which is often associated with higher premiums in taxi fares. The second solution entails the designation of actual, permanent or physical taxi stands at strategic locations (e.g., mall entrances, transportation hubs, hotel driveways, major street intersections, etc.) to direct both commuters and taxis to common locations.

Recent advancements in mobile technology have enabled commuters to hail or book taxis via mobile applications. However, there are at least three main limitations to these conventional mobile application solutions. Firstly, they do not enforce government policies that restrict areas to hail or board a taxi. Secondly, they lack the unification of pickup locations, which encourages bypassing queues when hailing a taxi via an e-hailing application. Lastly, congestions may result from taxis picking up passengers based on their locations. Such problems are social in nature, and can easily escalate into more serious issues if they are not well managed.

Therefore, there is a need for an improved framework that addresses the above-mentioned challenges.

### SUMMARY

A framework for coordinating transportation is described herein. In accordance with one implementation, the framework creates or selects a virtual transportation stand in response to a commuter request. The virtual transportation stand may be created or selected based at least in part on current location information associated with a mobile device. Information associated with the virtual transportation stand may then be provided to the commuter mobile device and a vehicle notification device. The virtual transportation stand may further be removed if it is no longer in demand.

In accordance with another implementation, the framework receives a commuter request and current location information associated with a commuter mobile device. The framework may further retrieve data source information, including weather information, traffic information, maps, traffic regulations, or a combination thereof, from one or more data sources. The framework may create or select a virtual transportation stand based at least in part on the current location information and the data source information. Information associated with the virtual transportation stand may then be provided to the commuter mobile device and a vehicle notification device. The virtual transportation stand may further be removed if it is no longer in demand.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows an exemplary dashboard rendered by a mobile application;

FIG. 3 shows an exemplary dashboard rendered by a vehicle application;

FIG. 4 shows an exemplary dashboard rendered by a virtual transportation stand manager; and

FIG. 5 shows an exemplary method of coordinating transportation.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for coordinating transportation by creating and managing virtual transportation stands is described herein. A “transportation stand”, as used herein, generally refers to a common queue area where transportation vehicles (e.g., taxis, limousines, mini-buses, etc.) line up to wait for passengers, and where passengers line up to wait for and be picked up by transportation vehicles. Such stand generally works on a first-come, first-served basis, so that the first transportation vehicle to arrive at the stand serves the first passenger to arrive. The transportation stand described herein is “virtual” since it is not an actual stand that is permanently marked by a painted sign, but is created on demand by the present framework to serve the needs of nearby commuters and removed when it is no longer in demand. The presence (and absence) of a virtual transportation stand may be indicated on a display device within a digital environment. Such devices include, for instance, a mobile device displaying a map, a signboard, a lamp post or any other device that can be switched on and off or otherwise updated to indicate the presence (or absence) of the virtual transportation stand.

The present framework provides a new paradigm to elevate the level of communication and existing service level. In accordance with some implementations, a central computer system guides a transportation vehicle to the nearest virtual transportation stand once it becomes available. This can advantageously result in an increase in the revenue of the transportation vehicle operator through a higher utilization rate. The virtual transportation stand may be created at a safe and optimal location that is determined based on current information, such as weather reports, traffic conditions and regulations. Transportation vehicle drivers need not worry about violating road regulations or causing traffic slowdown by picking up passengers by the roadside.

In addition, commuters need not waste time waiting on the phone to get connected to a call center operator to book transportation, or to wait for a vehicle to be assigned. Commuters can also avoid having to pay for any fees associated with a booking service. Even further, commuters also do not need to take the chance to hail, for example, a taxi by walking to locations where they know taxis typically drive pass, or move to the “upstream” of traffic to increase the chances of finding a taxi. At the virtual transportation stand, commuters (or potential passengers) can be informed of, for instance, the estimated waiting time based on the length of the queue and the availability of vehicles. The transparency of such information can greatly improve the experience and satisfaction of the commuters.

In some implementations, the central computer system manages the length of the queue at the virtual transportation stand by balancing the demand and supply over different stands, and distributing commuters and vehicles to various different locations. This is a vast improvement over traditional taxi stands where long queues and bottlenecks commonly occur.

It should be appreciated that the present framework may be described in the context of taxi stands for purposes of illustration only. The present framework may also be applied to other forms of public transportation vehicles, including ground, air and/or sea transportation vehicles. It should also be appreciated that the framework described herein may be implemented as a method, a computer-controlled apparatus, a computer process, a computing system, or as an article of manufacture such as a computer-usable medium. These and various other features and advantages will be apparent from the following description.

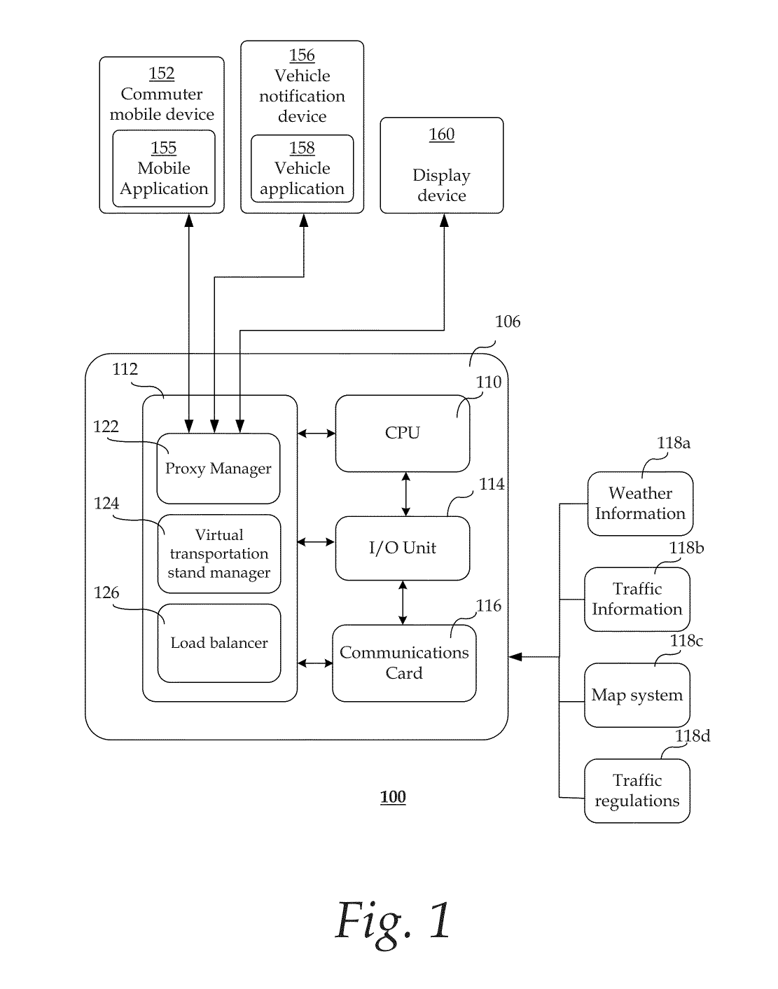

FIG. 1 is a block diagram illustrating an exemplary architecture 100 that may be used to implement the framework described herein. Generally, architecture 100 may include a central computer system 106, multiple data sources 118a-d, one or more commuter mobile devices 152, and one or more vehicle notification devices 156.

Central computer system 106 can be any type of computing device capable of responding to and executing instructions in a defined manner, such as a workstation, a server, a portable laptop computer, another portable device, a mini-computer, a mainframe computer, a storage system, a dedicated digital appliance, a device, a component, other equipment, or some combination of these. Central computer system 106 may include a central processing unit (CPU) or processor 110, an input/output (I/O) unit 114, a memory module 112 and a communications card or device 116 (e.g., modem and/or network adapter) for exchanging data with a network (e.g., a local area network (LAN) or a wide area network (WAN)). It should be appreciated that the different components and sub-components of the computer system 106 may be located on different machines or systems.

Central computer system 106 may be communicatively coupled to one or more other computer systems or devices via the network. For instance, computer system 106 may further be communicatively coupled to one or more data sources 118a-d. Data sources 118a-d may include, for example, any database (e.g., relational database, in-memory database, etc.), an entity (e.g., set of related records), a data set included in a database, or a combination thereof. Such data sources 118a-d may be provided by external parties.

In some implementations, the computer system 106 is communicatively coupled to a weather information data source 118a, a traffic information data source 118b, a map system 118c and/or a traffic regulations data source 118d. Weather information data source 118a provides information of local weather conditions and forecasts, including warnings of bad weather (e.g., thunderstorms) that may influence the ability of commuters to access the transportation vehicles at non-sheltered areas. Traffic information data source 118b provides information of traffic conditions, including adverse traffic conditions (e.g., congestion) due to, for instance, vehicle break-down, accidents or peak rush hours that may delay the arrival of the transportation vehicle or affect the commuter's access to the vehicle. Map system 118c provides maps and routing information, such as map tiles, street names and/or points-of-interest. Traffic regulations data source 118d provides information of traffic rules and laws, including, for instance, no stopping or standing locations, restricted zones, etc.

Central computer system 106 may act as a server and operate in a networked environment using logical connections to one or more commuter mobile devices 152, one or more vehicle notification devices 156 and/or one or more display devices 160. Commuter mobile device 152 may include a mobile application (or App) 155 that communicates with the central computer system 106 and presents a user interface or dashboard to receive requests for transportation from the user and to provide transportation information and updates (e.g., estimated arrival time of transportation vehicle, nearest virtual transportation stand, queue number, etc.). Such commuter mobile devices may include, for example, smart phone, tablet computer, laptop communication device, etc.

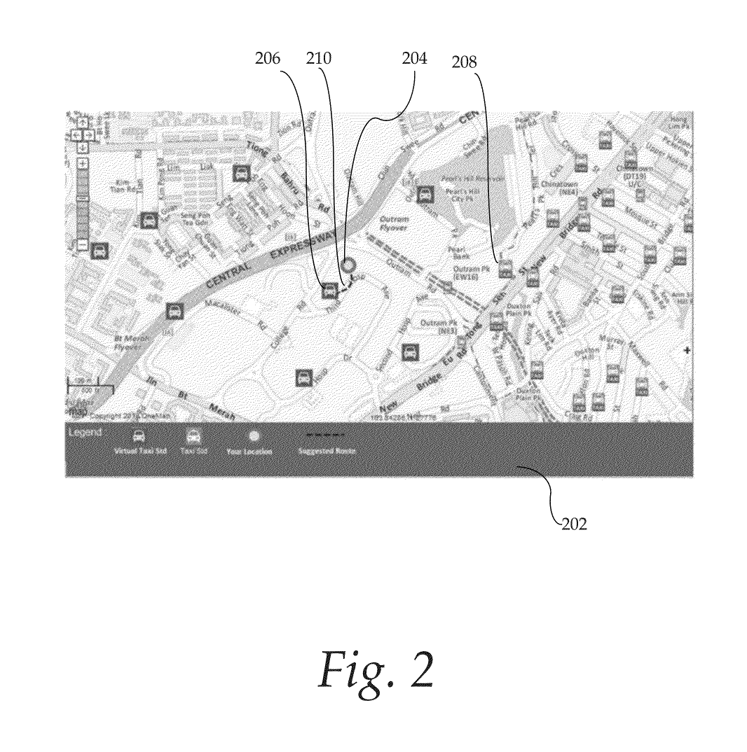

FIG. 2 shows an exemplary dashboard 202 rendered by the mobile application 155. The dashboard 202 presents a map that shows the commuter's current location 204, nearby virtual taxi stands 206 created by the present framework, and actual taxi stands 208. A suggested route 210 from the commuter's current location 204 to a virtual taxi stand 206 may also be displayed to guide the commuter to the nearest virtual taxi stand 206, which is positioned by the framework at the best possible location by taking into account information from the various data sources 118a-d.

The vehicle notification device 156 may include a vehicle application 158 that serves as a communication interface between the vehicle driver and the central computer system 106. The vehicle notification device 156 may include components similar to a computer system, such as an input device for receiving user input (e.g., touch screen, keypad, speech recognition component, etc.), an output device for displaying a user interface, a communications card, memory for storing a vehicle application 158, a processor for executing the vehicle application 158, and so forth. The vehicle notification device 156 may also be a mobile device, such as a smart phone, tablet computer, laptop communication device, etc.

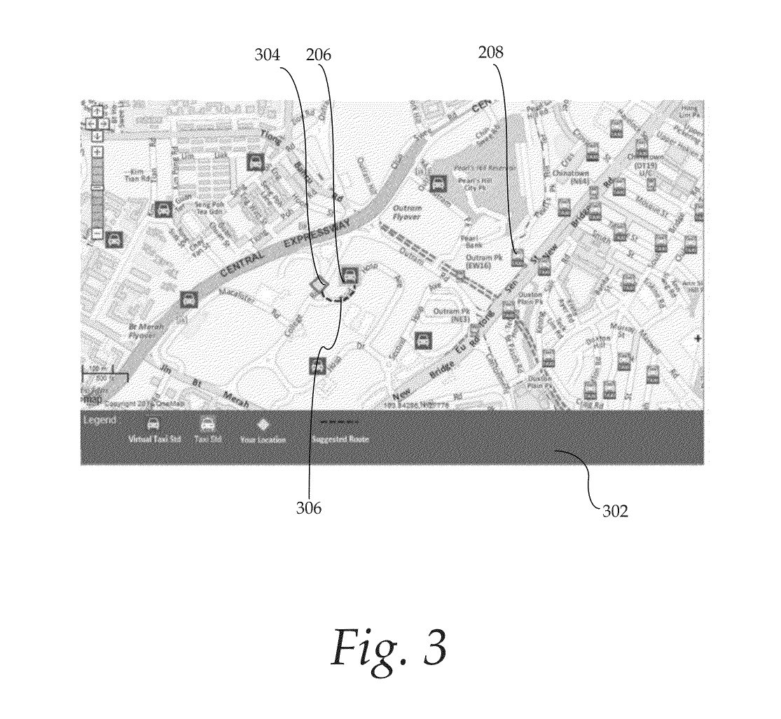

FIG. 3 shows an exemplary dashboard 302 rendered by the vehicle application 158. The dashboard 302 presents a map that shows the taxi's current location 304, nearby virtual taxi stands 206 created by the present framework, and actual taxi stands 208. A suggested route 306 from the taxi's current location 304 to a virtual taxi stand 206 may also be displayed to guide the taxi to the nearest virtual taxi stand 206 to pick up passengers there. The suggested route 306 may be generated based on existing conditions, such as road or traffic conditions, weather, etc.

Referring back to FIG. 1, the display device 160 may serve to indicate to both commuters and transportation vehicle drivers the presence of a virtual transportation stand at the particular location where the display device 160 is located. In some implementations, the display device 160 may be switched on or illuminated to indicate the presence of a virtual transportation stand, and switched off to indicate the absence or removal of the virtual transportation stand when it is no longer needed. Exemplary display devices 160 include, but are not limited to, digital signboards, lamp posts, billboards, electronic signs, light-emitting diodes (LED) signs, neon signs, and so forth.

Referring back to FIG. 1, memory module 112 of the central computer system 106 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by CPU 110. As such, the computer system 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

In some implementations, memory module 112 of the central computer system 106 includes a proxy manager 122, a virtual transportation stand manager 124 and a load balancer 126. Proxy manager 122 may include a set of function modules or programs designed to communicate with external devices, such as commuter mobile devices 152, vehicle notification devices 156 and display devices 160. In some implementations, the proxy manager 122 collects incoming requests for transportation from commuters via the mobile applications 155 implemented in commuter mobile device 152. The proxy manager 122 may aggregate the incoming requests from different commuter mobile devices 152 before sending the request data to the virtual transportation stand manager 124. Once a virtual transportation stand is created or located, the proxy manager 122 may send information, such as the location of the recommended virtual transportation stand, vehicle queue length at the stand and suggested driving route to the stand to the vehicle notification device 156. Similarly, the commuter mobile device 152 may be notified of the location of the recommended virtual transportation stand, passenger queue length at the stand and suggested walking route to the stand. The proxy manager 122 may also notify the display device 160 (if any) that is positioned at the virtual transportation stand location if the stand is newly created or removed.

Virtual transportation stand manager 124 may include a set of function models or programs designed to use the request data to dynamically create and manage a set of one or more virtual transportation stands. Load balancer 126 may include a set of function models or programs designed to balance the demand and supply of transportation between the virtual transportation stands so as to reduce bottlenecks and queues.

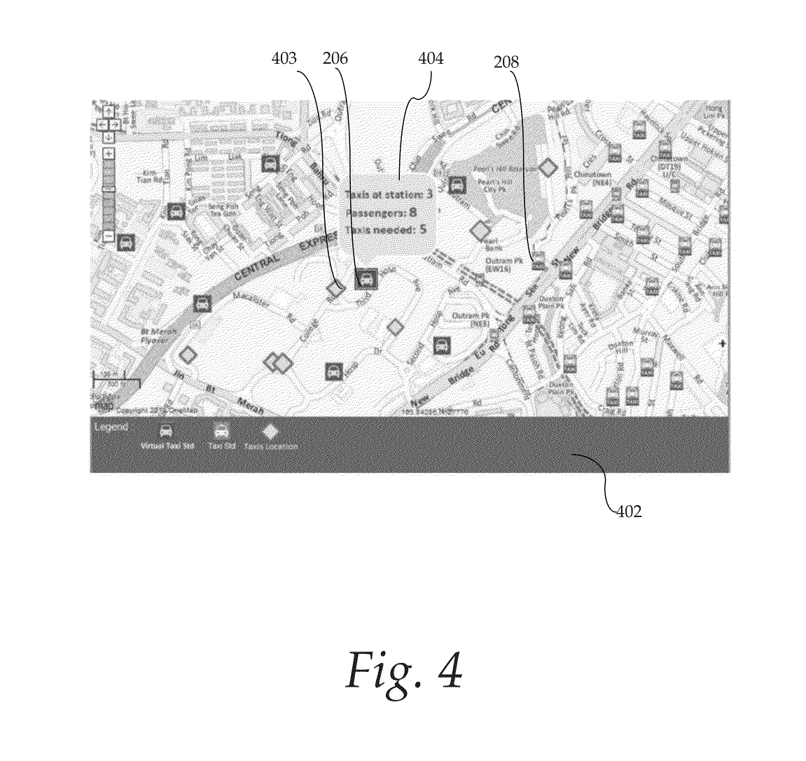

FIG. 4 shows an exemplary dashboard 402 rendered by the virtual transportation stand manager 124. The dashboard 402 presents a map that shows the locations of available taxis 403, nearby virtual taxi stands 206 created by the present framework, and actual taxi stands 208. Additional demand and supply information 404 at each virtual taxi stand 206 may also be displayed.

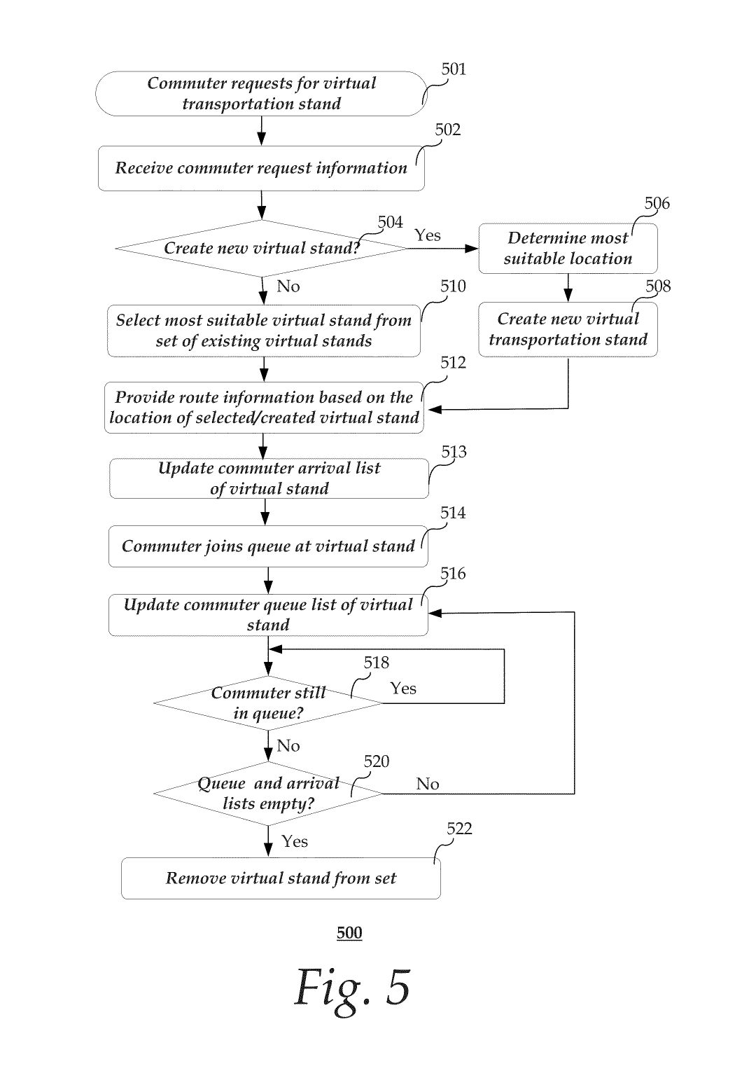

FIG. 5 shows an exemplary method 500 of coordinating transportation by creating and managing virtual transportation stands. The process 500 may be performed automatically or semi-automatically by the central computer system 106, as previously described with reference to FIG. 1. It should be noted that in the following discussion, reference will be made, using like numerals, to the features described in FIG. 1.

At 501, a commuter makes a request for a virtual transportation stand. The commuter may indicate his or her ad-hoc request via mobile application 155 implemented on commuter mobile device 152. In some implementations, the commuter may specify one or more request requirements, such as the number of transportation vehicles desired, the preferred mode of transportation (e.g., taxi), the preferred transportation service provider, the preferred time of pick-up, preferred location or area of pick-up, etc. Other types of information may also be specified in the request.

At 502, the proxy manager 122 receives the commuter request information from the commuter mobile device 152. The commuter request information may include the requirements specified by the commuter, as well as the current location information of the commuter (or commuter mobile device 152) and other relevant information associated with the commuter mobile device 152 (e.g., passenger information).

The current location information may be automatically provided, in whole or part, by a global positioning system (GPS), an assisted-GPS (A-GPS) system, a WiFi-based system, a locator-based mobile triangulation system, or other types of positioning system communicatively coupled with, or implemented on, the commuter mobile device 152. Alternatively, the current location information may be derived from location identifying information provided by the commuter via the mobile device 152. The commuter may indicate his or her location by providing, for instance, a postal code, name of a nearby landmark, building name, lamp post identifier, address, or any other location identifying information.

In some implementations, the proxy manager 122 retrieves data source information from one or more data sources 118a-d. As discussed previously, the data sources 118a-d may include, but are not limited to, a weather information data source 118a, a traffic information data source 118b, a map system 118c and/or a traffic regulations data source 118d. Other types of data sources may also be used. Accordingly, the data source information may include weather information, traffic information, routing information and/or traffic regulations. By combining information from such data sources, the present framework may advantageously influence the travel pattern of both commuters and transportation vehicles so as to improve traffic conditions and ease congestion.

At 504, the virtual transportation stand manager 124 determines if a new virtual transportation stand needs to be created in response to the commuter request. In some implementations, the virtual transportation stand manager 124 invokes the load balancer 126 to determine if any stand in a set of existing virtual transportation stands is suitable for the current commuter request. The load balancer 126 may serve to distribute supply and demand for transportation between existing virtual transportation stands. This is performed to avoid over-demand (e.g., long queues of passengers) or over-supply (e.g., long queues of taxis) at any virtual transportation stand.

The load balancer 126 may determine whether any existing virtual stand is suitable based at least in part on proximity of the existing stand to the commuter's current location. For instance, the load balancer 126 may search for an existing virtual transportation stand that is within a predetermined radius of the commuter's current location.

Additionally, the load balancer 126 may further make the determination based on current supply and demand for transportation at existing virtual transportation stands. The current supply and demand for transportation at each virtual transportation stand may be determined based on current commuter queue length, current commuter arrival list length, current vehicle queue length, current vehicle arrival list length, commuter queue capacity, vehicle queue capacity, or a combination thereof. For example, if the number of commuters currently queuing at the existing stand (i.e. current commuter queue length) equals or exceeds the commuter queue capacity or a predetermined threshold (i.e. over-demand), the load balancer 126 may determine that the existing stand is not suitable so as to avoid over-crowding the stand. In another example, if the number of transportation vehicles currently queuing at the existing stand (i.e. current vehicle queue length) equals or exceeds the vehicle queue capacity (i.e., over-supply), the load balancer 126 may also determine that the existing stand is not suitable so as to avoid over-supplying the stand. If none of the existing stands is suitable, then a virtual transportation stand needs to be created, and the method 500 continues at 506. Otherwise, the method 500 continues at 510.

At 506, the virtual transportation stand manager 124 determines a most suitable location to position a new virtual transportation stand. In some implementations, the location is optimized based on the request information, location and/or data source information. The virtual transportation stand manager 124 may determine a location that is nearest to the commuter's location and also satisfies the constraints imposed by the request information and/or data source information. For instance, if the weather information indicates adverse weather conditions (e.g., rain or thunderstorm), the virtual transportation stand manager 124 may select, based on the map information, the nearest location that is sheltered and does not violate any traffic regulations (e.g., illegal stopping). Other types of constraints are also possible.

At 508, the virtual transportation stand manager 124 creates the new virtual transportation stand at the most suitable or optimal location. The newly created virtual stand may be stored in the set of existing virtual transportation stands. Each virtual transportation stand may be associated with a unique identifier, time/date of creation, duration from time of creation, remaining valid duration (which may be determined by local regulations), a location, a commuter arrival list, a vehicle arrival list, a commuter queue list, a vehicle queue list, and so forth.

The commuter arrival list keeps track of the passengers arriving at the virtual transportation stand, while the commuter queue list keeps track of the passengers that are already waiting or queuing at the virtual transportation stand. The commuter arrival list and the commuter queue list may include information of the commuter mobile device 152 or personal information (e.g., name, contact information, etc.) associated with each passenger who is arriving or queuing respectively.

Similarly, the vehicle arrival list keeps track of the available transportation vehicles heading towards or arriving at the virtual transportation stand, while the vehicle queue list keeps track of the transportation vehicles that are already waiting or queuing at the virtual transportation stand. The vehicle arrival list and the vehicle queue list may include information of the vehicle notification device 156 or vehicle information (e.g., driver's name, contact information, operator, license plate, etc.) associated with each vehicle that is arriving or queuing respectively.

At 510, the load balancer 126 selects the most suitable virtual stand from the set of existing virtual transportation stands. As discussed previously, the most suitable existing virtual stand may be determined based on, for instance, the proximity of the existing virtual transportation stand to the current location of the commuter. Other information, such as current commuter queue length, current commuter arrival list length, current vehicle queue length, current vehicle arrival list length, commuter queue capacity, vehicle queue capacity, or a combination thereof, may also be used to determine the most suitable existing virtual stand. The selected virtual stand may also need to satisfy the constraints imposed by the request information and/or data source information.

At 512, the proxy manager 122 provides route information based on the location of the selected or newly created virtual transportation stand to navigate the commuter and the vehicle driver to the selected or newly created virtual stand. The proxy manager 122 may provide the route information to the commuter mobile device 152 via the mobile application 155, as well as to the vehicle notification device 156 via the vehicle application 158. The route information may include, for example, a suggested walking route for the commuter, as well as a suggested driving route for the vehicle. The route information may be determined by using, for example, the Dijkstra algorithm or variations thereof, to find the shortest path between the virtual transportation stand and the vehicle or commuter. The route information may be graphically presented on the commuter mobile device 152 as a suggested route 210 on a map displayed by dashboard 202, as previously described with reference to FIG. 2. Similarly, the route information provided to the vehicle notification device 156 may be graphically presented as a suggested route 306 on a map displayed by dashboard 302, as previously described with reference to FIG. 3.

In some implementations, the proxy manager 122 also updates the display device 160 (if any) positioned at the location of the selected or newly created virtual transportation stand to indicate to commuters and transportation vehicles the presence of the virtual transportation stand. The display device 160 may be switched on or illuminated to display a sign or text that indicates the presence of the virtual transportation stand.

At 513, the virtual transportation stand manager 124 updates the commuter arrival list associated with the selected or newly created virtual transportation stand. The commuter arrival list may be updated by, for instance, adding information associated with the commuter, such as an identifier, name, contact information, current location, etc. The proxy manager 122 may send a “queue” number to the mobile application 155 to inform the commuter the number of passengers that are ahead of him or her in the queue.

At 514, the commuter joins the queue at the virtual transportation stand. The mobile application 155 may automatically detect the commuter's arrival by matching the commuter mobile device's location with the location of the virtual transportation stand, or in response to the commuter's interaction with the mobile application 155. In response to detecting the commuter's arrival at the virtual transportation stand, the mobile application 155 may send a first confirmation message to the proxy manager 122.

At 516, the virtual transportation stand manager 124 updates the commuter queue list associated with the selected or newly created virtual transportation stand. The commuter queue list may be updated by adding, for example, information associated with the commuter (e.g., identifier, name, contact information, location, etc.). The proxy manager 122 then sends the updated queue list information to one or more nearest available transportation vehicles via vehicle applications 158. A vehicle driver may then accept the job by interacting with the vehicle application 158.

At 518, virtual transportation stand manager 124 monitors the location of the commuter mobile device 152 to determine if the commuter is still waiting in the queue. The virtual transportation stand manager 124 may determine that the commuter is not in the queue if the location of the commuter mobile device 152 does not match the location of the virtual transportation stand. The commuter may not be waiting in the queue if he or she decides to leave the queue and not wait for transportation, or if the commuter is picked up by a transportation vehicle.

If the commuter is picked up by a transportation vehicle, the vehicle application 158 may send a second confirmation message to the proxy manager 122. Such confirmation message may be sent automatically upon detecting the location of the vehicle matches that of the virtual transportation stand, or in response to the vehicle driver's interaction with the vehicle application 158.

At 520, the virtual transportation stand manager 124 determines if the commuter queue and commuter arrival lists associated with the virtual transportation stand are empty. If not, the method 500 proceeds to 516 to update the commuter queue list to exclude information associated with the commuter who has left the queue. If the lists are empty, it may be determined that there is no demand for the virtual transportation stand, and the method 500 proceeds to 522.

At 522, the virtual transportation stand manager 124 removes the virtual transportation stand. The virtual transportation stand may be removed by, for example, deleting information associated with the virtual transportation stand from the set of existing virtual transportation stands. In some implementations, the proxy manager 122 may update the display device 160 so as to remove any indication of the virtual transportation stand. The display device 160 may be, for instance, switched off.

The present framework is advantageously adaptive to changes in data source information obtained from external data sources 118a-d (e.g., regulations, weather, road conditions, etc.). In addition, historical transportation demand and supply information derived from, for example, request information, commuter queue lists, commuter arrival lists, vehicle queue lists, vehicle arrival lists, etc. may be compiled over time and stored for further analysis. Such transportation demand and supply information may be provided to government authorities and/or transport operators for planning and policy management.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method of coordinating transportation, comprising:
receiving a commuter request and current location information associated with a commuter mobile device;
retrieving, from one or more data sources, data source information including weather information, traffic information, maps, traffic regulations, or a combination thereof;
creating or selecting a virtual transportation stand based at least in part on the current location information and the data source information;
providing, to the commuter mobile device and a vehicle notification device, information associated with the virtual transportation stand; and
if no demand exists for the virtual transportation stand, removing the virtual transportation stand.

2. A method of coordinating transportation, comprising:
receiving a commuter request and current location information associated with a commuter mobile device;
in response to the commuter request, creating or selecting a virtual transportation stand based at least in part on the current location information;
providing, to the commuter mobile device and a vehicle notification device, information associated with the virtual transportation stand; and
if no demand exists for the virtual transportation stand, removing the virtual transportation stand.

3. The method of claim 2 wherein the current location information is received from a global positioning system (GPS), an assisted-GPS (A-GPS) system, a WiFi-based system or a locator-based mobile triangulation system.

4. The method of claim 2 wherein the current location information is derived from location identifying information provided by a commuter via the commuter mobile device.

5. The method of claim 2 wherein creating or selecting the virtual transportation stand comprises creating the virtual transportation stand by determining an optimal location that is nearest to the current location and satisfies one or more constraints imposed by data source information.

6. The method of claim 5 wherein the data source information includes weather information, traffic information, maps, traffic regulations, or a combination thereof.

7. The method of claim 2 wherein creating or selecting the virtual transportation stand based at least in part on the current location information comprises:
determining whether any existing virtual transportation stand is suitable based at least on proximity of the existing virtual transportation stand to the current location;
if no existing virtual transportation stand is determined to be suitable, creating the virtual transportation stand; and
if an existing virtual transportation stand is determined to be suitable, selecting the existing virtual transportation stand.

8. The method of claim 7 wherein determining whether any existing virtual transportation stand is suitable comprises determining whether any existing virtual transportation stand is suitable based at least in part on current commuter queue length, current commuter arrival list length, current vehicle queue length, current vehicle arrival list length, commuter queue capacity, vehicle queue capacity, or a combination thereof.

9. The method of claim 8 wherein the existing virtual transportation stand is determined to be unsuitable if the current commuter queue length equals or exceeds the commuter queue capacity or a predetermined threshold.

10. The method of claim 8 wherein the existing virtual transportation stand is determined to be not suitable if the current vehicle queue length equals or exceeds the vehicle queue capacity or a predetermined threshold.

11. The method of claim 2 wherein the information associated with the virtual transportation stand includes route information to navigate the commuter and the vehicle to the virtual transportation stand.

12. The method of claim 11 further comprising graphically presenting the route information on a map.

13. The method of claim 2 further comprising:
indicating, via a display device positioned at a location of the created or selected virtual transportation stand, presence of the virtual transportation stand.

14. The method of claim 13 wherein removing the transportation stand includes removing, via the display device, any indication of the presence of the virtual transportation stand.

15. The method of claim 2 further comprising:
updating a commuter arrival list associated with the created or selected virtual transportation stand with information associated with a commuter;
detecting the commuter's arrival at the virtual transportation stand; and
in response to the commuter's arrival, updating a commuter queue list associated with the virtual transportation stand.

16. The method of claim 15 further comprising:
providing the updated commuter queue list to the vehicle notification device.

17. The method of claim 15 further comprising:
providing a queue number to the commuter mobile device.

18. The method of claim 2 further comprising determining no demand exists for the virtual transportation stand if a commuter queue list and a commuter arrival list associated with the virtual transportation stand are empty.

19. A computer readable medium embodying a program of instructions executable by a machine to perform steps for coordinating transportation, the steps comprising:
receiving a commuter request and current location information associated with a commuter mobile device;
creating or selecting a virtual transportation stand based at least in part on the commuter request and the current location information;
providing, to the commuter mobile device and a vehicle notification device, information associated with the virtual transportation stand; and
if no demand exists for the virtual transportation stand, removing the virtual transportation stand.

20. A system comprising:
a memory device for storing computer readable program code; and
a processor in communication with the memory device, the processor being operative with the computer readable program code to perform steps for coordinating transportation, the steps comprising:
receiving a commuter request and current location information associated with a commuter mobile device;
creating or selecting a virtual transportation stand based at least in part on the commuter request and the current location information;
providing, to the commuter mobile device and a vehicle notification device, information associated with the virtual transportation stand; and
if no demand exists for the virtual transportation stand, removing the virtual transportation stand.
